(19) United States
(12) Patent Application Publication
(10) Pub. No.: US 2023/0398392 A1
(43) Pub. Date: Dec. 14, 2023

(54) SMART FIRE DETECTION SYSTEMS AND METHODS

(71) Applicant: Tyco Fire Products LP, Lansdale, PA (US)

(72) Inventors: Andrew Rohde, Marinette, WI (US); Luke Charles Giwojna, Coleman, WI (US); Sean S. Troutt, Stephenson, MI (US); Noah Williams, Marinette, WI (US); Robert Farley, Ashburnham, MA (US); Kenneth Savage, Fitchburg, MA (US)

(21) Appl. No.: 17/838,919

(22) Filed: Jun. 13, 2022

(51) Int. Cl. A62C 37/44

(52) U.S. Cl. CPC A62C 37/44

(57) ABSTRACT

A fire detection and suppression system includes a fire suppression system configured to suppress a fire in an area, a temperature sensor configured to measures a zone temperature for each of a plurality of zones in the area, and a controller. The controller is configured to receive the zone temperatures from the temperature sensor for each of the plurality of zones, detect a hazard condition in a first zone of the plurality of zones based on the zone temperature for the first zone, and activate the fire suppression system in response to detecting the hazard condition in the first zone.

### BACKGROUND

Fire suppression systems are commonly used to protect an area and objects within the area from fire. Fire suppression systems can be activated manually or automatically in response to an indication that a fire is present nearby (e.g., an increase in temperature beyond a predetermined threshold value, etc.). Once activated, fire suppression systems spread a fire suppression agent throughout the area. The fire suppressant agent then extinguishes or prevents the growth of the fire.

### SUMMARY

One implementation of the present disclosure is a fire detection and suppression system, according to some embodiments. In some embodiments, the fire detection and suppression system includes a fire suppression system configured to suppress a fire in an area, a temperature sensor configured to measure a zone temperature for each of a plurality of zones in the area, and a controller. The controller is configured to receive the zone temperatures from the temperature sensor for each of the plurality of zones, detect a hazard condition in a first zone of the plurality of zones based on the zone temperature for the first zone, and activate the fire suppression system in response to detecting the hazard condition in the first zone.

In some embodiments, the temperature sensor is a grid temperature sensor including a plurality of pixels, such that each of the plurality of zones corresponds to at least one of the plurality of pixels of the grid temperature sensor.

In some embodiments the zone temperature for each of the plurality of zones includes a pixel reading for the plurality of pixels corresponding to each of the zones.

In some embodiments the fire suppression system includes a first section configured to suppress a fire in the first zone and a second section configured to suppress a fire outside the first zone, wherein the first section and the second section are individually controllable. In some embodiments the controller is further configured to activate the first section of the fire suppression system in response to detecting the hazard condition in the first zone.

In some embodiments the fire suppression system includes a plurality of nozzles, wherein each of the plurality of zones is associated with at least one of the plurality of nozzles, and in response to detecting the hazard condition in the first zone, selectively activate at least one of the plurality of nozzles associated with the first zone. In some embodiments the controller is further configured, in response to detecting the hazard condition in the first zone, to selectively activate at least one of the plurality of nozzles associated with the first zone and at least one of the plurality of nozzles associated with a third zone adjacent to the first zone.

In some embodiments the controller is further configured to detect a second hazard condition in the first zone based on the zone temperature for the first zone, and reactivate the fire suppression system in response to detecting the second hazard condition in the first zone.

In some embodiments the controller is further configured to detect a hazard condition in the first zone when the zone temperature for the first zone satisfies a maximum temperature condition. In some embodiments the maximum temperature condition is based on an appliance within the first zone. In some embodiments the controller is further configured to receive the maximum temperature condition via a user input. In some embodiments, the controller is further configured to associate an appliance with the first zone, and determine the maximum temperature condition for the first zone based on the appliance.

Another implementation of the present disclosure is a method operating a fire detection and suppression system. In some embodiments, the method includes providing a fire suppression system configured to suppress a fire in an area, providing a temperature sensor configured to measure a zone temperature for each of a plurality of zones in the area, detecting, based on the zone temperatures, a hazard condition in at least one of the plurality of zones, activating the fire suppression system in response to detecting the hazard condition.

In some embodiments, the fire suppression system includes a fire suppression tank configured to contain a volume of fire suppressant, a nozzle having an outlet at least selectively fluidly coupled to the fire suppression tank and configured to release a spray of the fire suppressant therefrom, and an activator configured to selectively release the fire suppressant from the fire suppression tank such that at least a section of the fire suppressant passes through the outlet of the nozzle, wherein the nozzle.

In some embodiments, the fire suppression system includes a first section configured to suppress a fire in the first zone and a second section configured to suppress a fire outside the first zone, wherein the first section and the second section are individually controllable, the method further including the steps of activating the first section of the fire suppression system in response to detecting the hazard condition.

In some embodiments, the method includes detecting a second hazard condition in the first zone based on the zone temperature for the first zone, and reactivating the fire suppression system in response to detecting the second hazard condition in the first zone.

In some embodiments, the temperature sensor includes a plurality of pixels, such that each of the plurality of zones corresponds to at least one of the plurality of pixels of the temperature sensor.

In some embodiments, the fire suppression system includes a plurality of individually controllable sections, each section corresponding to at least one of the plurality of zones.

Another implementation of the present disclosure is a controller for a fire suppression system in a hazard area, according to some embodiments. In some embodiments, the controller includes processing circuitry configured to receive a plurality of zone temperatures from a temperature sensor positioned in the hazard area, wherein each of the plurality of zone temperatures correspond to a zone of a plurality of zones in the hazard area, detect a hazard condition in a first zone of the hazard area based on a zone temperature of the plurality of zone temperatures corresponding to the first zone, and activate the fire suppression system in response to detecting the hazard condition in the first zone. The fire suppression system includes a fire suppression tank configured to contain a volume of fire suppressant, a plurality of nozzles having outlets at least selectively fluidly coupled to the fire suppression tank and configured to release sprays of the fire suppressant therefrom, wherein each of the plurality of nozzles is associated with at least one of the plurality of zones, and an activator configured to selectively activate the fire suppression system individually in each of the plurality of zones, such that in response to detecting the hazard condition in the first zone the fire suppression system selectively releases fire suppressant in the first zone and not in a second zone of the plurality of zones.

In some embodiments, the processing circuitry if further configured to detect a second hazard condition in the first zone, and reactivate the fire suppression system in the first zone.a

### BRIEF DESCRIPTION OF THE DRAWINGS

FIG. 1 is a schematic of a fire detection and suppression system, according to some embodiments.

FIG. 2 is an illustration of a fire detection and suppression system in a hazard area, according to some embodiments.

FIG. 3 is a block diagram of the controller of FIG. 2, according to some embodiments.

FIG. 4 is a top-top down view of the fire detection and suppression system of FIG. 2 in a hazard area, including a field of viewing field of the temperature sensor of FIG. 2, according to some embodiments.

FIG. 5 is an illustration of the fire detection and suppression system of FIG. 2 in a hazard area, according to some embodiments.

FIG. 6 is a flow diagram of a fire detection and suppression process for a fire detection and suppression system, according to some embodiments.

### DETAILED DESCRIPTION

Before turning to the figures, which illustrate the exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the FIGURES, a fire detection and suppression system for a hazard area is shown, according to some embodiments. The system includes a temperature sensor configured to measure a heat map of the hazard area. In some embodiments, the temperature sensor is an infrared (“IR”) grid sensor with a plurality of pixels making up a viewing field of the grid sensor. In some embodiments, the pixels are associated with zones in the hazard area. In some embodiments, the temperature sensor is configured to measure the temperatures within the zones (i.e., zone temperatures) of the hazard area (e.g., kitchen, workshop, etc.). In some embodiments, the zone temperature of a zone includes the pixel readings for each pixel associated with the zone. According to some embodiments the system includes a controller. In some embodiments, the zones are provided to the controller via a user input. In some embodiments, the controller automatically divides the hazard area into zones based on one or more inputs (e.g., zone temperatures, images, layouts, appliance placements, etc.). In some embodiments, the controller updates/adjusts the zones based on the position of appliances (e.g., fryers, ovens, grills, etc.) within the hazard area. In some embodiments, the controller is configured to receive the zone temperatures for the zones in the hazard area from the temperature sensor. In some embodiments, the controller is configured to detect a hazard condition in one of the zones and/or the hazard area based on the temperature signals. As used herein, a hazard condition includes not just a hazard (e.g., a fire) but also a state of affairs determined to likely result in a hazard (e.g., a fire). In some embodiments, the controller associates a maximum temperature condition with each of the zones in the hazard area and/or the hazard area. In some embodiments, the maximum temperature condition(s) are based on one or more characteristics of the zones and/or hazard area (e.g., location, size, number of appliances included, type of appliances included, prior temperatures, etc.). In some embodiments, the controller automatically determines the maximum temperature condition for each zone and/or the hazard area. In some embodiments, the maximum temperature condition(s) are provided to the controller via a user input. In some embodiments, the controller detects a hazard condition in a zone when the zone temperature and/or hazard area temperature satisfies the associated maximum temperature condition. In some embodiments, the controller activates the fire suppression system in response to detecting a hazard condition. In some embodiments, the fire suppression system is divided into multiple, individually controllable, sections. In some embodiments, each of the sections correspond with at least one of the zones. In some embodiments, the controller only activates the sections of the fire suppression system associated with the zone(s) where a hazard condition is detected. In some embodiments, the controller activates the sections of the fire suppression system associated with the zone(s) where a hazard condition is detected and any adjacent zones. In some embodiments, after activating the fire suppression system in response to detecting a hazard condition in a zone, the controller detects a second hazard condition the hazard. In some embodiments, the controller activates/reactivates the sections of fire suppression system associated with the zone in response to detecting the second hazard condition. In some embodiments, the controller activates multiple different sections in response to different hazards conditions in different zones.

Advantageously, using the fire detection and suppression system as shown in the FIGURES and described in the accompanying description reduces the need for a fusible link to detect and activate a fire suppression system, according to some embodiments. Accordingly, the fire detection and suppression system can be reactivated without the need to replace parts of the detection and/or suppression system. Additionally, the fire suppression system reduces the need for manual updates to a layout of the hazard area by automatically monitoring the hazard area and updating the layout in response to a detected change (e.g., appliance is moved, appliance is removed, appliance is added, etc.) Finally, the fire detection and suppression system may be configured to detect a hazard condition in one or more zones which are individually addressable by the fire suppression system, increasing the effectiveness of the fire suppressant by concentrating its use in zones a hazard condition is detected in and reducing and/or eliminating its use in zones a hazard condition is not detected in.

### Fire Suppression System

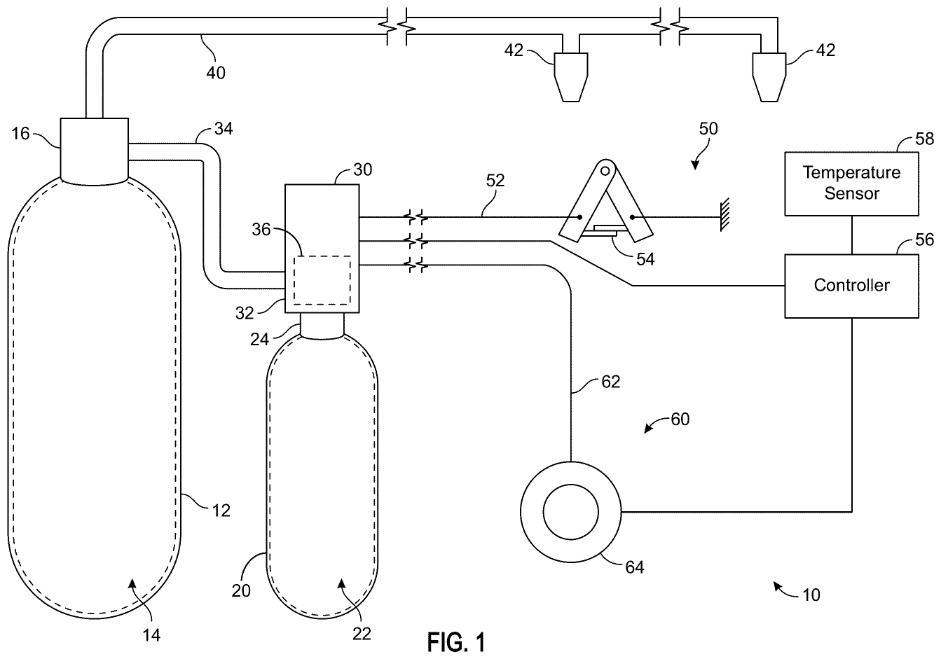

Referring to FIG. 1, a fire suppression system 10 is shown according to an exemplary embodiment. In one embodiment, the fire suppression system 10 is a chemical fire suppression system. The fire suppression system 10 is configured to dispense or distribute a fire suppressant agent onto and/or nearby a fire, suppressing/extinguishing the fire and preventing the fire from spreading. The fire suppression system 10 can be used alone or in combination with other types of fire suppression systems (e.g., a building sprinkler system, a handheld fire extinguisher, etc.). In some embodiments, multiple fire suppression systems 10 are used in combination with one another to cover a larger area (e.g., each in different rooms of a building).

The fire suppression system 10 can be used in a variety of different applications. Different applications can require different types of fire suppressant agent and different levels of mobility. The fire suppression system 10 is usable with a variety of different fire suppressant agents, such as powders, liquids, foams, or other fluid or flowable materials. The fire suppression system 10 can be used in a variety of stationary applications. By way of example, the fire suppression system 10 is usable in kitchens (e.g., for oil or grease fires, etc.), in libraries, in data centers (e.g., for electronics fires, etc.), at filling stations (e.g., for gasoline or propane fires, etc.), or in other stationary applications. Alternatively, the fire suppression system 10 can be used in a variety of mobile applications. By way of example, the fire suppression system 10 can be incorporated into land-based vehicles (e.g., racing vehicles, forestry vehicles, construction vehicles, agricultural vehicles, mining vehicles, passenger vehicles, refuse vehicles, etc.), airborne vehicles (e.g., jets, planes, helicopters, etc.), or aquatic vehicles, (e.g., ships, submarines, etc.).

Referring again to FIG. 1, the fire suppression system 10 includes a fire suppressant tank 12 (e.g., a vessel, container, vat, drum, tank, canister, cartridge, or can, etc.). The fire suppressant tank 12 defines an internal volume 14 filled (e.g., partially, completely, etc.) with fire suppressant agent. In some embodiments, the fire suppressant agent is normally not pressurized (e.g., is near atmospheric pressure). The fire suppressant tank 12 includes an exchange section, shown as neck 16. The neck 16 permits the flow of expellant gas into the internal volume 14 and the flow of fire suppressant agent out of the internal volume 14 so that the fire suppressant agent can be supplied to a fire.

The fire suppression system 10 further includes a cartridge 20 (e.g., a vessel, container, vat, drum, tank, canister, cartridge, or can, etc.). The cartridge 20 defines an internal volume 22 configured to contain a volume of pressurized expellant gas. The expellant gas can be an inert gas. In some embodiments, the expellant gas is air, carbon dioxide, or nitrogen. The cartridge 20 includes an outlet section or outlet section, shown as neck 24. The neck 24 defines an outlet fluidly coupled to the internal volume 22. Accordingly, the expellant gas can leave the cartridge 20 through the neck 24. The cartridge 20 can be rechargeable or disposable after use. In some embodiments where the cartridge 20 is rechargeable, additional expellant gas can be supplied to the internal volume 22 through the neck 24.

The fire suppression system 10 further includes a valve, puncture device, or activator assembly, shown as actuator 30. The actuator 30 includes an adapter, shown as receiver 32, that is configured to receive the neck 24 of the cartridge 20. The neck 24 is selectively coupled to the receiver 32 (e.g., through a threaded connection, etc.). Decoupling the cartridge 20 from the actuator 30 facilitates removal and replacement of the cartridge 20 when the cartridge 20 is depleted. The actuator 30 is fluidly coupled to the neck 16 of the fire suppressant tank 12 through a conduit or pipe, shown as hose 34.

The actuator 30 includes an activation mechanism 36 configured to selectively fluidly couple the internal volume 22 to the neck 16. In some embodiments, the activation mechanism 36 includes one or more valves that selectively fluidly couple the internal volume 22 to the hose 34. The valves can be mechanically, electrically, manually, or otherwise actuated. The valves can be opened to release a portion of the expellant gas from the cartridge 20, closed, and then opened again to release another portion of expellant gas from the cartridge. In some such embodiments, the neck 24 includes a valve that selectively prevents the expellant gas from flowing through the neck 24. Such a valve can be manually operated (e.g., by a lever or knob on the outside of the cartridge 20, etc.) or can open automatically upon engagement of the neck 24 with the actuator 30. Such a valve facilitates removal of the cartridge 20 prior to depletion of the expellant gas. In other embodiments, the cartridge 20 is sealed, and the activation mechanism 36 includes a pin, knife, nail, or other sharp object that the actuator 30 forces into contact with the cartridge 20. This punctures the outer surface of the cartridge 20, fluidly coupling the internal volume 22 with the actuator 30. In some embodiments, the activation mechanism 36 punctures the cartridge 20 only when the actuator 30 is activated. In some such embodiments, the activation mechanism 36 omits any valves that control the flow of expellant gas to the hose 34. In other embodiments, the activation mechanism 36 automatically punctures the cartridge 20 as the neck 24 engages the actuator 30.

Once the actuator 30 is activated and the cartridge 20 is fluidly coupled to the hose 34, the expellant gas from the cartridge 20 flows freely through the neck 24, the actuator 30, and the hose 34 and into the neck 16. The expellant gas forces fire suppressant agent from the fire suppressant tank 12 out through the neck 16 and into a conduit or hose, shown as pipe 40. In one embodiment, the neck 16 directs the expellant gas from the hose 34 to a top section of the internal volume 14. The neck 16 defines an outlet (e.g., using a syphon tube, etc.) near the bottom of the fire suppressant tank 12. The pressure of the expellant gas at the top of the internal volume 14 forces the fire suppressant agent to exit through the outlet and into the pipe 40. In other embodiments, the expellant gas enters a bladder within the fire suppressant tank 12, and the bladder presses against the fire suppressant agent to force the fire suppressant agent out through the neck 16. In yet other embodiments, the pipe 40 and the hose 34 are coupled to the fire suppressant tank 12 at different locations. By way of example, the hose 34 can be coupled to the top of the fire suppressant tank 12, and the pipe 40 can be coupled to the bottom of the fire suppressant tank 12. In some embodiments, the fire suppressant tank 12 includes a burst disk that prevents the fire suppressant agent from flowing out through the neck 16 until the pressure within the internal volume 14 exceeds a threshold pressure. Once the pressure exceeds the threshold pressure, the burst disk ruptures, permitting the flow of fire suppressant agent. Alternatively, the fire suppressant tank 12 can include a valve, a puncture device, or another type of opening device or activator assembly that is configured to fluidly couple the internal volume 14 to the pipe 40 in response to the pressure within the internal volume 14 exceeding the threshold pressure. Such an opening device can be configured to activate mechanically (e.g., the force of the pressure causes the opening device to activate, etc.) or the opening device may include a separate pressure sensor in communication with the internal volume 14 that causes the opening device to activate.

The pipe 40 is fluidly coupled to one or more outlets or sprayers, shown as nozzles 42. The fire suppressant agent flows through the pipe 40 and to the nozzles 42. The nozzles 42 each define one or more apertures, through which the fire suppressant agent exits, forming a spray of fire suppressant agent that covers a desired area. The sprays from the nozzles 42 then suppress or extinguish fire within that area. The apertures of the nozzles 42 can be shaped to control the spray pattern of the fire suppressant agent leaving the nozzles 42. The nozzles 42 can be aimed such that the sprays cover specific points of interest (e.g., a specific piece of restaurant equipment, a specific component within an engine compartment of a vehicle, etc.). The nozzles 42 can be configured such that all of the nozzles 42 activate simultaneously, or the nozzles 42 can be configured such that only the nozzles 42 near the fire are activated.

The fire suppression system 10 further includes an automatic activation system that can control the activation of the actuator 30. The automatic activation system 50 is configured to monitor one or more conditions and determine if those conditions are indicative of a nearby fire. Upon detecting a nearby fire, the automatic activation system activates the actuator 30, causing the fire suppressant agent to leave the nozzles 42 and extinguish the fire.

In some embodiments, the actuator 30 is controlled mechanically. As shown in FIG. 1, the automatic activation system 50 includes a mechanical system including a tensile member (e.g., a rope, a cable, etc.), shown as cable 52, that imparts a tensile force on the actuator 30. Without this tensile force, the actuator 30 will activate. The cable 52 is coupled to a fusible link 54, which is in turn coupled to a stationary object (e.g., a wall, the ground, etc.). The fusible link 54 includes two plates that are held together with a solder alloy having a predetermined melting point. A first plate is coupled to the cable 52, and a second plate is coupled to the stationary object. When the ambient temperature surrounding the fusible link 54 exceeds the melting point of the solder alloy, the solder melts, allowing the two plates to separate. This releases the tension on the cable 52, and the actuator 30 activates. In other embodiments, the automatic activation system 50 is another type of mechanical system that imparts a force on the actuator 30 to activate the actuator 30. The automatic activation system 50 can include linkages, motors, hydraulic or pneumatic components (e.g., pumps, compressors, valves, cylinders, hoses, etc.), or other types of mechanical components configured to activate the actuator 30. Some parts of the automatic activation system 50 (e.g., a compressor, hoses, valves, and other pneumatic components, etc.) can be shared with other parts of the fire suppression system 100 (e.g., the manual activation system 60) or vice versa.

The actuator 30 can additionally or alternatively be configured to activate in response to receiving an electrical signal from the automatic activation system 50. Referring to FIG. 1, the automatic activation system 50 includes a controller 56 that monitors signals from one or more sensors, shown as temperature sensor 58 (e.g., infrared grid sensor, high-speed infrared camera, etc.). The controller 56 can use the signals from the temperature sensor 58 to determine a temperature a hazard condition. In some embodiments, the temperature sensor 58 can view the hazard area in a grid, with pixels of the temperature sensor corresponding to cells in the grid. The temperature sensor 58 can sense the temperature in each pixel, and thereby determine a location of a hazard condition in the hazard area. The controller 56 can determine a hazard condition exists when a maximum temperature condition is reached. A maximum temperature condition can be a maximum measured temperature from an individual pixel in the temperature sensor 58; a maximum average temperature in one or more pixels, a zone, the hazard area etc.; a threshold number of pixels above a certain temperature; etc. The controller 56 can determine a hazard condition is present when the maximum temperature condition is satisfied based on the readings from the temperature sensor 58. Upon determining that a hazard condition is present, the controller 56 provides an electrical signal to the actuator 30. The actuator 30 then activates in response to receiving the electrical signal.

The fire suppression system 10 further includes a manual activation system 60 that can control the activation of the actuator 30. The manual activation system 60 is configured to activate the actuator 30 in response to an input from an operator. The manual activation system 60 can be included instead of or in addition to the automatic activation system 50. Both the automatic activation system 50 and the manual activation system 60 can activate the actuator 30 independently. By way of example, the automatic activation system 50 can activate the actuator 30 regardless of any input from the manual activation system 60, and vice versa.

As shown in FIG. 1, the manual activation system 60 includes a mechanical system including a tensile member (e.g., a rope, a cable, etc.), shown as cable 62, coupled to the actuator 30. The cable 62 is coupled to a human interface device (e.g., a button, a lever, a switch, a knob, a pull ring, etc.), shown as button 64. The button 64 is configured to impart a tensile force on the cable 62 when pressed, and this tensile force is transferred to the actuator 30. The actuator 30 activates upon experiencing the tensile force. In other embodiments, the manual activation system 60 is another type of mechanical system that imparts a force on the actuator 30 to activate the actuator 30. The manual activation system 60 can include linkages, motors, hydraulic or pneumatic components (e.g., pumps, compressors, valves, cylinders, hoses, etc.), or other types of mechanical components configured to activate the actuator 30.

The actuator 30 can additionally or alternatively be configured to activate in response to receiving an electrical signal from the manual activation system 60. As shown in FIG. 1, the button 64 is operably coupled to the controller 56. The controller 56 can be configured to monitor the status of a human interface device (e.g., engaged, disengaged, etc.). Upon determining that the human interface device is engaged, the controller provides an electrical signal to activate the actuator 30. By way of example, the controller 56 can be configured to monitor a signal from the button 64 to determine if the button 64 is pressed. Upon detecting that the button 64 has been pressed, the controller 56 sends an electrical signal to the actuator 30 to activate the actuator 30.

The automatic activation system 50 and the manual activation system 60 are shown to activate the actuator 30 both mechanically (e.g., though application of a tensile force through cables, through application of a pressurized liquid, through application of a pressurized gas, etc.) and electrically (e.g., by providing an electrical signal). It should be understood, however, that the automatic activation system 50 and/or the manual activation system 60 can be configured to activate the actuator 30 solely mechanically, solely electrically, or through some combination of both. By way of example, the automatic activation system 50 can omit the controller 56 and activate the actuator 30 based on the input from the fusible link 54. By way of another example, the automatic activation system 50 can omit the fusible link 54 and activate the actuator 30 using an input from the controller 56.

### Fire Detection and Alert System

### System Overview

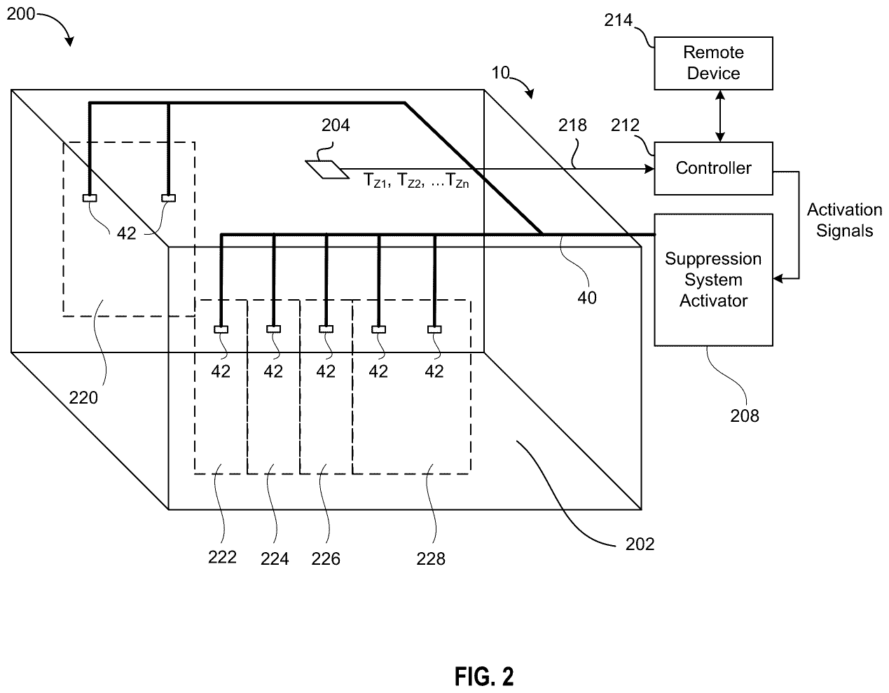

Referring now to FIG. 2, a fire detection and suppression system 200 is shown, according to an exemplary embodiment. In some embodiments, fire detection and suppression system 200 is or includes automatic activation system 50. In some embodiments, fire detection and suppression system 200 is configured to cause automatic activation system 50 to activate fire suppression system 10 in response to detecting a hazard condition (e.g., a maximum temperature condition, a fire, etc.). In some embodiments, fire detection and suppression system 200 includes all of the functionality of automatic activation system 50. In some embodiments, fire detection and suppression system 200 replaces automatic activation system 50 and is configured to cause actuator 30 and/or activation mechanism 36 to allow fluid to flow out of fire suppressant tank 12 and/or cartridge 20. In some embodiments, fire detection and suppression system 200 is configured to activate fire suppression system 10 such that the expellant gas exits internal volume 22 of cartridge 20 through neck 24 and the fire suppressant exits internal volume 14 of fire suppressant tank 12 through neck 16 into a hazard area 202. Fire detection and suppression system 200 includes fire suppression system 10, which itself includes but is not limited to pipe 40 and nozzles 42; temperature sensor 204, suppression system activator 208, controller 212, and remote device 214, according to some embodiments. Fire detection and suppression system 200 is configured to generate a heat map of the hazard area 202. Fire detection and suppression system 200 is configured to generate the heat map by measuring temperatures across the hazard area 202 using one or more temperature sensors, such as temperature sensor 204 in order to detect fires and/or hazard conditions, according to some embodiments. Fire detection and suppression system 200 is configured to divide (e.g., partition, split, layout, etc.) hazard area 202 into one or more zones, shown as zones 220, 222, 224, 226, and 228, according to some embodiments. The zones 220-228 can correspond to zones or areas on the heat map generated by the temperature sensor 204. Temperature sensor 204 can individually sense the temperature within each zone 220-228. In some embodiments, the temperature sensor 204 can sense multiple temperatures within each zone 220-228 and for generating a zone temperature for each zone 220-228. The zone temperature can include the individual temperature readings, or be based on the temperature readings such as a minimum, a maximum, an average, etc. The zones 220-228 can include one or more nozzles 42. In some embodiments, fire suppression system 10 is similarly divided (e.g., partitioned, split, laid out, etc.) into multiple individually controllable sections (portions, pieces, areas, etc.). The nozzles 42 within each section can be individually controlled to release a fire suppressant therefrom. For example, the nozzles 42 in a zone can be selectively controlled, such that the nozzles 42 in one zone 220-228, for example 220, can be activated while the nozzles 42 in zone 222 can remain deactivated. In some embodiments, multiple sections can be activated at or near the same time or in sequence in response to the same hazard condition. In some embodiments, each section of fire suppression system 10 includes the nozzles 42 associated with an individual zone 220-228. Advantageously, fire detection and suppression system 200 can be used as an early detection and fire prevention system to detect a fire (e.g., hazard condition) before it occurs based on signals from the temperature sensor 204, and notify a user to prevent the fire before the fire actually starts.

Fire detection and suppression system 200 includes one or more sensors, shown as temperature sensor 204, according to some embodiments. In some embodiments, temperature sensor 204 is an infrared (IR) sensor. In some embodiments, the temperature sensor 204 is configured to generate a heat map of part and/or all of the hazard area. In some embodiments, the temperature sensor 204 is a IR grid sensor with a viewing field or grid composed of multiple pixels. The pixels in the temperature sensor 204 can individually sense the temperature in their respective portion of the temperature sensor 204's viewing field, in order to generate the heat map. In some embodiments, temperature sensor 204 is configured to measure/monitor a temperature in one or more zones 220-228. In some embodiments, temperature sensor 204 is positioned (e.g., coupled, mounted, removably attached, etc.) to a ceiling of a hazard area 202 (e.g., kitchen, workshop, etc.). interior surface of hood 202.

Temperature sensor 204 is configured to provide controller 212 with real time temperature readings, according to some embodiments. In some embodiments, temperature sensor 204 provides controller 212 with signals indicating one or more real time temperature readings (e.g., temperature measurements, monitored temperature values, sensed temperature values, etc.). In some embodiments, temperature sensor 204 provides controller 212 with temperature readings for each zone 220-228 in a hazard area 202. In some embodiments, the zone temperatures are aggregate temperatures based on the temperature readings in the zone. In some embodiments, the zone temperatures are the set of temperature readings located in the zone. In some embodiments, where the temperature sensor 204 is an IR grid sensor, the zones 220-228 correspond to one or more pixels in the temperature sensor 204, and the temperature sensor 204 provides a real time zone temperature (e.g., average temperature, individual pixel temperature, etc.) for each of the zones 220-228. As shown in FIG. 2, only a single temperature sensor 204 is used in fire detection and suppression system 200, however, more than one temperature sensor 204 may be used (e.g., two, three, four, etc.). In some embodiments, temperature sensor 204 is configured to wirelessly communicate with controller 212 to provide controller 212 with the real time temperature readings. In some embodiments, temperature sensor 204 is wiredly and communicably connected to controller 212 (e.g., via wire 218). In some embodiments, wire 218 is cladded (e.g., coated, surrounded, enclosed within, etc.) with a thermally resistive material. In some embodiments the thermally resistive material prevents wire 218 from becoming damaged due to high temperatures to which wire 218 may be exposed.

Controller 212 is configured to receive the real time temperature readings from temperature sensor 204 and determine if a hazard condition (e.g., a fire, a potential fire, a high-risk of fire, etc.) has occurred or will occur based on the real time temperature readings, according to some embodiments. In some embodiments, controller 212 includes a Human Machine Interface (HMI). Controller 212 may be configured to detect sudden changes of the real time temperature readings and provide suppression system activator 208 with activation signals. In some embodiments, suppression system activator 208 is configured to receive the activation signals from controller 212 and activate fire suppression system 10. Fire suppression system 10 includes one or more nozzles 42 fluidly coupled to suppressant tank 12 via pipe 40, according to some embodiments. In some embodiments, suppression system activator 208 is configured to activate fire suppression system 10 such that fire suppressing agent flows out of the fire suppressant tank 12, through pipe 40, and exits nozzles 42 to extinguish a fire present in hood 202. In some embodiments, suppression system activator 208 is configured to activate actuator 30 in response to receiving activation signals from controller 212. In some embodiments, the fire suppression system 10 is divided into one or more sections, each section containing one or more nozzles, and the suppression system activator 208 is configured to activate select nozzles 42 in select sections in response to receiving activation signals from controller 212. For example, controller 212 can detect a hazard condition in a zone 220 based on temperature readings (e.g., zone temperature readings) from the temperature sensor 204, and suppression system activator 208 can activate fire suppression system 10 to release fire suppressant from the fire suppressant section associated with zone 220, including from all nozzles 42 in zone 220 without releasing fire suppressant from nozzles 42 in the remaining zones 222-228. In some embodiment, the controller 212 may be configured to detect multiple hazard conditions and provide multiple activation signals to suppression system activator 208. In some embodiments, the multiple activation signals are provided at different times. In some embodiments, the multiple activations signals are provided at or near the same time. In some embodiments, the suppression system activator 208 is configured to selectively activate multiple sections of the fire suppression system 10 in response to receiving one or more activation signals. In some embodiments, when a second hazard condition is received after a first hazard condition, the suppression system activator 208 can be configured to reactivate a section of the fire suppression system 10 in response to the second hazard condition which was already activated in response to the first hazard condition.

In some embodiments, the controller 212 is configured to monitor the hazard area 202 during activation of the fire suppression system 10 and selectively deactivate the fire suppression system 10 or the active section(s) of the fire suppression system 10 based on the temperature signals from the temperature sensor 204. In some embodiments, when the controller 212 no longer detects the hazard condition in the zones 220-228 and/or hazard area 202, the controller 212 provides the suppression system activator with a deactivation signals to deactivate the fire suppression system 10. In some embodiments, the controller 212 provides deactivation signals when a maximum temperature condition is no longer satisfied. In some embodiments, the controller 212 is configured to deactivate the fire suppression system 10 when the temperature in a zone is at or below a minimum safe temperature. In some embodiments, the controller 212 is configured to deactivated the fire suppression system 10 in response to an command from a user, for example via remote device 214.

In some embodiments, the controller 212 is configured to perform one or more other safety actions in addition or alternatively to activating the fire suppression system. In some embodiments, the controller 212 is configured to shut off a gas valve to a zone of and/or the entire hazard area, flip a breaker associated with the zone and/or hazard area, etc. It should be understood that the controller 212 can perform multiple safety actions at once or over time in response to detecting a hazard condition, including but not limited to activating the fire suppression system 10.

In some embodiments, controller 212 is configured to receive temperature readings from temperature sensor 204 over a learning period to determine characteristic/archetypal conditions for the hazard area 202 (including individual zones 220-228). For example, in some embodiments, zone 220 includes an appliance such as a stove, an oven, a fryer, etc. In some embodiments, the learning period facilitates controller 212 learning application temperatures (e.g., cooking) for each appliance, specific maximum temperatures, and other application (e.g., cooking) related data or the hazard area. In some embodiments, the learning period facilitates learning an average time, or acceptable peak temperatures, for a zone. In some embodiments, learning application specific temperatures and other application related data facilitates controller 212 to automatically develop a layout of the hazard area 202. In some embodiments, the controller 212 further develops individual zones within the layout based on the learning period. For example, a kitchen with a relatively high ambient temperature may have a different typical cooking temperature, while a kitchen with a very low ambient temperature may have a different typical cooking temperature. In some embodiments, the archetypal/characteristic/average values can be used by controller 212 to divide the hazard area 202 into one or more zones. The learning period facilitates controller 212 learning archetypal/characteristic/average values for any zone 220-228. In some embodiments, the learning period facilitates the controller 212 to determine if one or more monitored variables are unusual (e.g., unusually high) which may indicate a hazard condition (e.g., a fire). In some embodiments, the archetypal/characteristic/average values can be used by controller 212 to minimize spurious suppression actuation and achieve faster detection of abnormal application (e.g., cooking) values (e.g., cooking temperature, rise rate, temperature differentials, etc.). In some embodiments, the controller 212 is configured to determine characteristic/archetypal conditions and/or values as described in U.S. patent application Ser. No. 17/612,404, filed May 21, 2020, the entire disclosure of which is incorporated by reference herein.

In some embodiments, controller 212 is configured to automatically divide the hazard area 202 into zones 220-228. In some embodiments, temperature sensor 204 includes one or more other sensors, (e.g., visual light camera, radar, etc.) to scan a hazard area 202 and generate a heat map which is divided into zones 220-228. In some embodiments, the controller 212 divides the hazard area 202 into zones 220-228 based one or more learned characteristic/archetypal values. In some embodiments, the hazard area 202 is divided into one or more zones based on values such as average temperature, applicant type, appliance location, size, number of nozzles, location, etc. In some embodiments, the controller 212 is provided a layout of hazard area 202 including zones 220-228 by a user. The layout can include information on the types of appliances in zones 220-228, the maximum allowed temperature in some or all of the zones 220-228, the maximum temperature condition for some or all of the zones 220-228, etc. In some embodiments, the controller 212 can continually monitor the hazard area 202 and adjust the zones 220-228 in response to changes in the readings from temperature sensor 204 (e.g., temperatures, visual image data, etc.). For example, controller 212 may have sensed an oven in zone 220 in March due to its consistent and stable high temperatures, but in April sense the same consistent and stable temperatures in zone 222 and not zone 220. The controller 212 can recognize that the oven has moved and automatically adjust the layout of the zones 220-228, including reassigning maximum allowable temperatures, maximum temperature conditions, etc. from zone 220 to zone 222. In some embodiments, the controller 212 can adjust the layout of the zones 220-228 in hazard area 202 based on one or more other characteristics such as time, date, temperature, etc.

In some embodiments, controller 212 can reprogram itself to identify hazard conditions based on the archetypal/characteristic/average values specific to an application. In some embodiments, controller 212 can provide the characteristic values to a remote device 214 via a communications interface. In some embodiments, the communications interface is a component of controller 212. In some embodiments, the communications interface is any of or a combination of an RS-232 serial interface, a Bluetooth interface (e.g., a wireless interface), a USB interface, an Ethernet interface, etc. In some embodiments remote device 214 can be a personal computer, server, mobile device, distributed computing system, etc. In some embodiments, the characteristic values can be provided to controller 212 from the remote database, remote server, or remote device 214 for hazard condition detection. In some embodiments, controller 212 includes or is communicably connected to a Human Machine Interface (HMI). In some embodiments, the characteristic values can be accessed via HMI. In some embodiments, the learning period can be re-performed to re-determine the characteristic values for the specific application. In some embodiments, multiple learning periods can be performed, and the characteristic values for each learning period can be stored in the remote device 214 and/or locally in controller 212. In some embodiments, controller 212 is communicably connected (e.g., wirelessly) to a remote device 214. In some embodiments, the remote device can monitor real time temperature sensor information, performance data, and event/alarm/alert data. In some embodiments, the controller 212 can receive the layout of the zones 220-228, including the location of appliances in the hazard area 202, the maximum temperature conditions of each zone 220-228, etc., from the remote device 214. In some embodiments, the remote device 214 is a user device, and the information is provided by a user.

In some embodiments, controller 212 provides the characteristic values and real-time information to the remote device 214. In some embodiments, once the characteristic values are stored in the remote device 214, another device can communicably connect with the remote device 214, for example via mobile computing platforms. In some embodiments, only an authorized agent can access the characteristic values and/or real time information at the remote server/device.

It should be understood that while controller 212 as described herein receives temperatures (e.g., zone temperatures) from temperature sensor 204, controller 212 may also receive temperatures from a corresponding temperature sensor of a hazard area 202. In some embodiments, controller 212 can also monitor multiple hazard areas, with each hazard area including its own temperature sensor, zones, etc. Controller 212 can perform any of the functionality described herein to determine characteristic, archetypal, average, or typical values during normal operation of equipment at the hazard area and use the characteristic values to detect a hazard condition at the hazard area. Controller 212 can then operate or activate a fire suppression system (e.g., fire suppression system 10) to suppress a fire or reduce a likelihood of a fire occurring in the near future at the hazard area.

### Controller Diagram

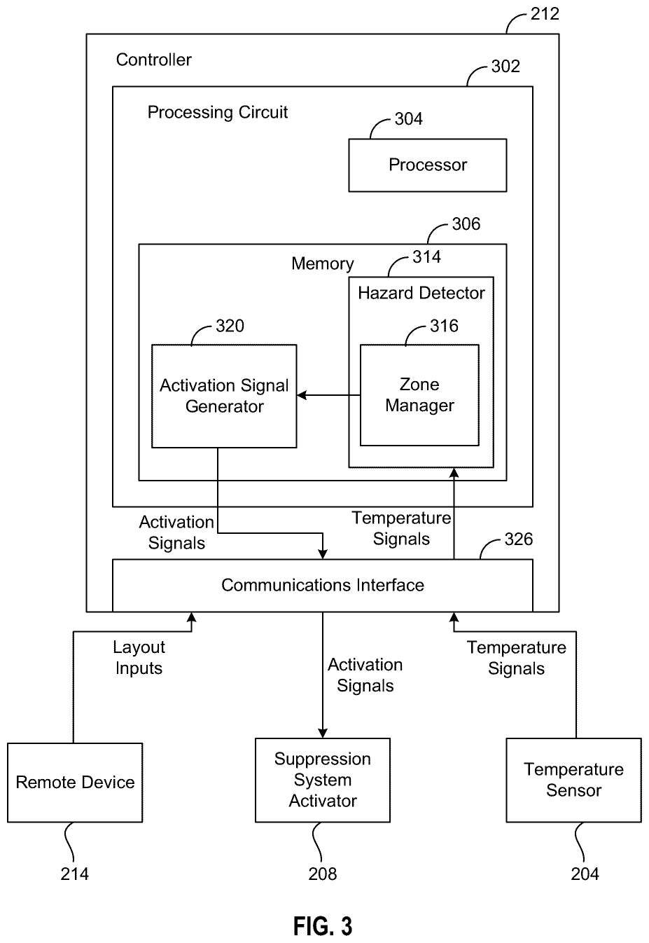

Referring now to FIG. 3, controller 212 is shown in greater detail, according to some embodiments. In some embodiments, controller 212 is configured to receive any of the real time temperature readings from temperature sensor 204 to determine if a hazard condition such as a fire has occurred or if a fire is likely to occur. In some embodiments, controller 212 is configured to receive temperature readings from temperature sensor 204 over a learning time period to determine one or more characteristic values the hazard area 202 including zones 220-228. In some embodiments, controller 212 is configured to receive the characteristic values from a user via a user input, for example via remote device 214.

Controller 212 is shown to include a communications interface 326, according to some embodiments. Communications interface 326 may facilitate communications between controller 212 and external applications (e.g., temperature sensor 204, etc.) for facilitating any of user control, monitoring, adjustment, etc., to any of temperature sensor 204, suppression system activator 208, or any other device, system, sensor, inputs, outputs, etc. Communications interface 326 may also facilitate communications between controller 212 and a remote server or remote system such as remote device 214. In some embodiments, communications interface is configured to facilitate communications between controller 212 and one or more external devices (e.g., a remote server, a remote device, a removable data storage device, etc.).

Communications interface 326 can be or include wired or wireless communications interfaces (e.g., jacks, antennas, transmitters, receivers, transceivers, wire terminals, etc.) for conducting data communications with any of suppression system activator 208, temperature sensor 204, remote device 214, or other external systems or devices. In various embodiments, communications via communications interface 326 can be direct (e.g., local wired or wireless communications) or via a communications network (e.g., a WAN, the Internet, a cellular network, etc.). For example, communications interface 326 can include an Ethernet card and port for sending and receiving data via an Ethernet-based communications link or network. In another example, communications interface 326 can include a Wi-Fi transceiver for communicating via a wireless communications network. In another example, communications interface 326 can include cellular or mobile phone communications transceivers.

Still referring to FIG. 3, controller 212 is shown to include a processing circuit 302 including a processor 304 and memory 306, according to some embodiments. Processing circuit 302 can be communicably connected to communications interface 326 such that processing circuit 302 and the various components thereof can send and receive data via communications interface 326. Processor 304 can be implemented as a general purpose processor, an application specific integrated circuit (ASIC), one or more field programmable gate arrays (FPGAs), a group of processing components, or other suitable electronic processing components.

Memory 306 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 306 can be or include volatile memory or non-volatile memory. Memory 306 can include database components, object code components, script components, or any other type of information structure for supporting the various activities and information structures described in the present application. According to some embodiments, memory 306 is communicably connected to processor 304 via processing circuit 302 and includes computer code for executing (e.g., by processing circuit 302 and/or processor 304) one or more processes described herein.

Referring still to FIG. 3, memory 306 is shown to include hazard detector 314. In some embodiments, hazard detector 314 is configured to receive the temperature signals from the temperature sensor 204 via the communication interface 326. In some embodiments, the hazard detector 314 determines if a hazard condition (e.g., a fire, a likely fire, etc.) exists based on the temperature signals. In some embodiments, the hazard detector 314 determines if a hazard condition is impending. In some embodiments, the hazard detector 314 determines if a hazard condition exists by determining if a maximum temperature condition has been satisfied. A maximum temperature condition is based on the temperature signals and indicates a fire is or is likely to occur. A maximum temperature condition can be a threshold temperature value, a threshold average temperature value over a period of time, an unusual sequence of temperature values, temperature values persistently above an average temperature value, etc. In some embodiments, the hazard detector 314 receives the maximum temperature condition from a user, for example a user of remote device 214 via communications interface 326. In some embodiments, the hazard detector 314 learns the maximum temperature condition over a learning period based on the temperature signals. In some embodiments, the maximum temperature condition is based on a learned characteristic values. In some embodiments, the hazard detector 314 generates a heat profile for the hazard area based on the temperature signals. In some embodiments, the hazard detector 314 detects a hazard by comparing the real time temperature signals from the temperature sensor 204 to a heat profile (e.g., heat map, etc.) of the hazard area generated over time and/or during a learning period. In some embodiments, hazard detector 314 is configured to receive temperature readings from the temperature sensor 204 in addition to input parameters from user, for example via remote device 214.

In some embodiments, hazard detector 314 includes zone manager 316. In some embodiments zone manager 316 is configured to associate temperature signals from the temperature sensor 204 with one or more zones in a hazard area. In some embodiments, the zone manager 316 is configured to create the zones in a hazard area. In some embodiments, the zone manager 316 divides the hazard area into one or more zones based on a layout of a hazard area, the location and type of appliances, the application the appliances are used for, the location of nozzles in the fire suppression system, prior measured temperature values, etc. For example, the zone manager 316 can use prior measured temperature values from the temperature sensor 204 to identify the location of one or more appliances in a hazard area based on the appliances temperature signature (i.e., temperature value, duration, use, etc.). The zone manager 316 can automatically divide the hazard area into zones based in part on the location of the one or more identified appliances. In some embodiments, an appliance is associated with multiple zones. In some embodiments, each zone includes one appliance. In some embodiments, the zone manager 316 can receive the information necessary to create one or more zones from via a user input. For example, a user can provide a layout of the hazard area, the position of one or more appliances, the temperature signature for one or more appliances, etc., and the zone manager 316 can use the information to create the zones. In some embodiments, the zone manager 316 is provided the zones for a hazard area by a user via a user input.

In some embodiments, the hazard detector 314 is configured to detect a hazard condition in the one or more zones generated by the zone manager 316. The hazard detector 314 can associate temperature signals from the temperature sensor 204 with the zones generated and/or managed by the zone manager 316 in order to detect hazard conditions in the zones individually and the hazard area as a whole.

Referring still to FIG. 3, memory 306 includes activation signal generator 320, according to some embodiments. In some embodiments, activation signal generator 320 receives the detection of the hazard condition in a zone of a hazard area and/or the hazard area from the hazard detector 314 and determines an appropriate response. In some embodiments, activation signal generator 320 generates an activation signal for the suppression system activator 208. In some embodiments, activation signal generator 320 performs another safety action (e.g., shutting of gas to a hazard area/zone, flipping a breaker for a hazard area/zone, etc.). In some embodiments, the activation signal generator 320 is configured to activate the entire fire suppression system in response to receiving a detection of a hazard condition from the hazard detector 314. In some embodiments, the activation signal generator 320 is configured to activate only the section of a fire suppression system associated with the location of the hazard condition. For example, the activation signal generator 320 receives a detection of a hazard condition in a first zone, and is configured to selectively activate the fire suppression system such that fire suppressant is released only from nozzles in the first zone (i.e., the section of the fire suppression system associated with the location of the hazard condition). In some embodiments, the activation signal generator 320 is configured to activate the section of the fire suppression system associated with the location of the detected hazard condition and one or more adjacent sections of the fire suppression system.

### Zones

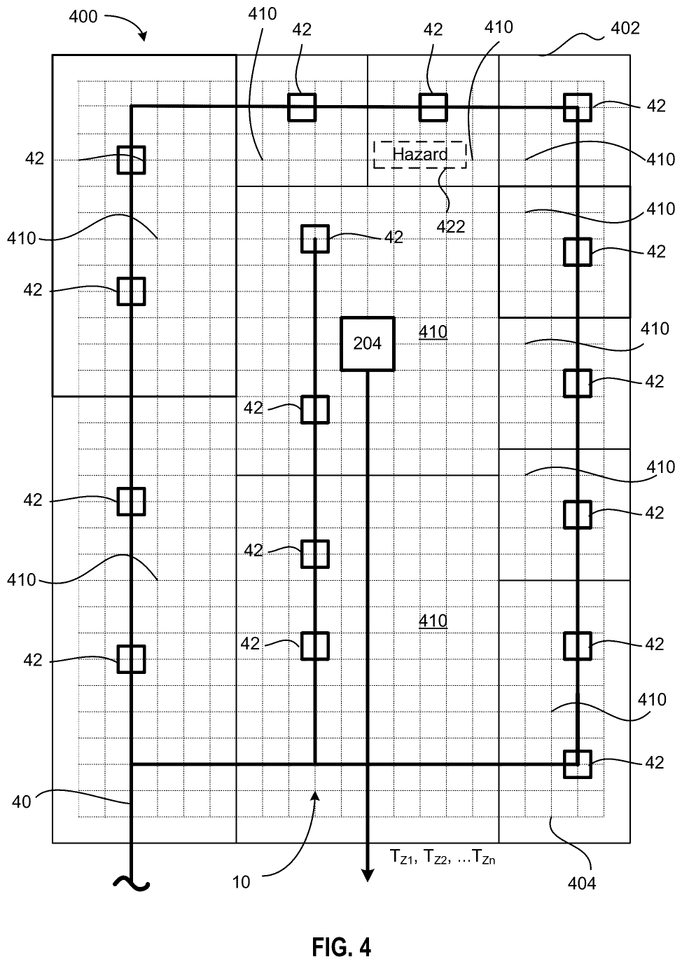

Referring now to FIG. 4, a top-down view of a fire detection and suppression system 300 in a hazard area 402 is shown, according to some embodiments. In some embodiments, fire detection and suppression system 400 is or includes automatic activation system 50. In some embodiments, fire detection and suppression system 400 is configured to cause automatic activation system 50 to activate fire suppression system 10 in response to detecting a hazard condition (e.g., a maximum temperature condition, a fire, etc.). In some embodiments, fire detection and suppression system 400 includes all of the functionality of automatic activation system 50. In some embodiments, fire detection and suppression system 400 replaces automatic activation system 50 and is configured to cause actuator 30 and/or activation mechanism 36 to allow fluid to flow out of fire suppressant tank 12 and/or cartridge 20. In some embodiments, fire detection and suppression system 400 includes and is configured to activate fire suppression system 10 such that the expellant gas exits internal volume 22 of cartridge 20 through neck 24 and the fire suppressant exits internal volume 14 of fire suppressant tank 12 through neck 16 into a hazard area 202. Fire detection and suppression system 400 includes fire suppression system 10 and temperature sensor 204, according to some embodiments. Fire detection and suppression system 400 is configured to monitor various temperature readings in the hazard area 202 from temperature sensor 204 to detect fires and/or hazard conditions, according to some embodiments.

Referring still to FIG. 4, hazard area 402 is shown to include temperature sensor 204. In some embodiments, temperature sensor 204 is a IR grid sensor with a plurality of pixels to provide a viewing field 404 in a grid shape with a plurality of cells corresponding to each pixel. In some embodiments, the viewing field 404 substantially matches the area of the hazard area 402. In some embodiments, the viewing field is smaller than the hazard area 402. In some embodiments, multiple temperature sensors 204 are provided in the hazard area 402 to cover the entire hazard area 402. As described above, in some embodiments each cell in the viewing field 404 corresponds to the field of view of a single pixel in the IR grid temperature sensor 204. The temperature sensor 204 is configured to measure the temperature pixel by pixel. In some embodiments, the temperature sensor 204 can locate a heat source in the hazard area 402 based on which pixels of the temperature sensor 204 detect the heat.

In some embodiments, the hazard area is divided into a plurality of zones 410. In some embodiments, each zone of the zones 410 is associated with multiple cells in the viewing field 404 of the temperature sensor 204. In some embodiments, the temperature sensor 204 is configured to measure a zone temperature (e.g., T_{Z1}, T_{Z2} . . . T_{Zn}) for each zone 410. In some embodiments, the zone temperature is the set of temperature values from the pixels associated with the zone. In some embodiments, the zone temperature is the average temperature value of the pixels in the zone. In some embodiments, the zone temperature for a zone 410 is otherwise based on the temperature values of the individual pixels associated with the zone 410 (e.g., maximum pixel value, minimum pixel value, average pixel value, etc.).

In some embodiments, a controller of the fire detection and suppression system 400 (e.g., controller 212) is configured to divide the hazard area 402 into the zones 410. In some embodiments the hazard area 402 is divided into the zones 410 based on one or more characteristics of the hazard area 402 including the position of the components of the fire suppression system 10, the location of the appliances, the type of appliances, the prior temperature values for the hazard area 402, one or more learned characteristic values, etc. In some embodiments, the zones 410 are input into the fire detection and suppression system by a user. In some embodiments, the fire detection and suppression system 400 is actively monitoring the temperature signals (e.g., T_{Z1}, T_{Z2} . . . T_{Zn}) from the temperature sensor 204 and determining if the zones should be adjusted. For example, an appliance may be moved, and the fire detection and suppression system 400 can detect a heat source present in the prior temperature readings (e.g., heatmap) for the hazard area 402 is no longer in the same zone 410, and can adjust the zones 410 accordingly. In some embodiments, adjusting the zones 410 includes learning and/or relearning one or more characteristic values for space. In some embodiments, adjust the zones 410 includes updating a maximum temperature condition for each zone 410.

Referring still to FIG. 4, each zone 410 includes one or more nozzles 42 of fire suppression system 10, according to some embodiments. In some embodiments the nozzles 42 of fire suppression system 10 are divided into sections, with each section associated with the zone 410 located within the section. In some embodiment, a zone 410 is located in a section with a single nozzle 42. In some embodiments, a zone 410 is located in a section that has multiple nozzles 42. In some embodiments, multiple zones 410 are included in a single section of the fire detection system 400. In some embodiments, the sections of the fire suppression system 400 are coextensive with the zones 410. In some embodiments, a zone 410 extend across multiple sections of the fire detection system 10.

In some embodiments, sections of the fire suppression system 10 are individually controllable. Each section can include one or more nozzles 42. In some embodiments, the sections include individually controllable valves for controlling fire suppressant to the sections. In some embodiments, the sections include individually controllable nozzles 42. For example, the fire suppression system 10 is configured to selectively activate the nozzle 42 in the section of the fire suppression 10 corresponding to zone 410 with the hazard 422. In further example, the nozzles in the remaining zones 410 can remain deactivated. Still in another example, the nozzles 42 in the zone 410 with the hazard 422 and the adjacent zones 410 can be selectively activated. In some embodiments, the fire suppression system 10 is not divided into sections but instead can be activated en masse.

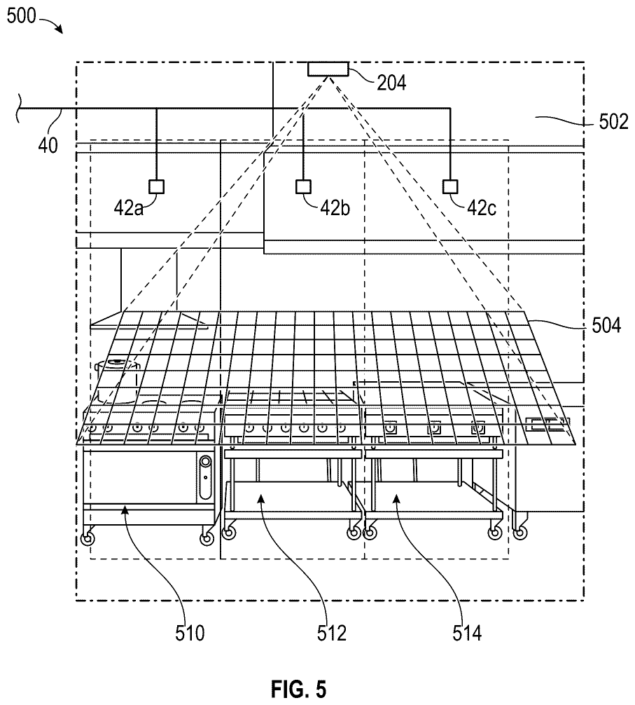

Referring now to FIG. 5, a fire detection and suppression system 500 in a hazard area 502 is shown, according to some embodiments. Hazard area 502 includes a temperature sensor, shown as temperature sensor 204. Temperature sensor 204 is a IR grid sensor with a viewing field 504 including a grid with a plurality of cells. The cells correspond to the individual field of view of each pixel in the temperature sensor 204. In some embodiments, the temperature sensor 204 is another kind of temperatures sensor, such as a high-speed IR camera, which can generate a heat map for an area. Hazard area 502 is divided three zones: zone 510, zone 512, and zone 514. In some embodiments, the zones 510-514 are determined automatically by the fire detection and suppression system 500. In some embodiments, the zones are provided to the fire detection and suppression system 500 by a user. The zones 510-514 each overlap with portions of the viewing field 504 of the temperature sensor 204. In some embodiments, the fire detection and suppression system 500 associates the temperature values for each cell of viewing field 504 with the zones 510-514 it overlaps with. In some embodiments, the temperature signals provided by the temperature sensor 204 includes the individual temperature signals from each pixel in the viewing field 504. In some embodiments, the temperature signals include a zone temperature based on the pixel temperatures of the pixels overlapping with the zone 510-514.

The zones 510-514 are shown to each include a nozzle 42a, 42b, and 42c, respectively. In some embodiments each nozzle 42a-42c belongs to a separate section of the fire detection and suppression system 500. In some embodiments, each section is independently controllable. For example, if a hazard or hazard condition is detected based on the temperature signals from the temperature sensor 204 in zone 510, the fire detection and suppression system 500 can selectively activate the section of the fire detection and suppression system 500 associated with zone 510 (i.e., nozzle 42a). Still in some embodiments, in response to the detection of a hazard condition the fire suppression system can activate all nozzles 42a-42c.

### Process

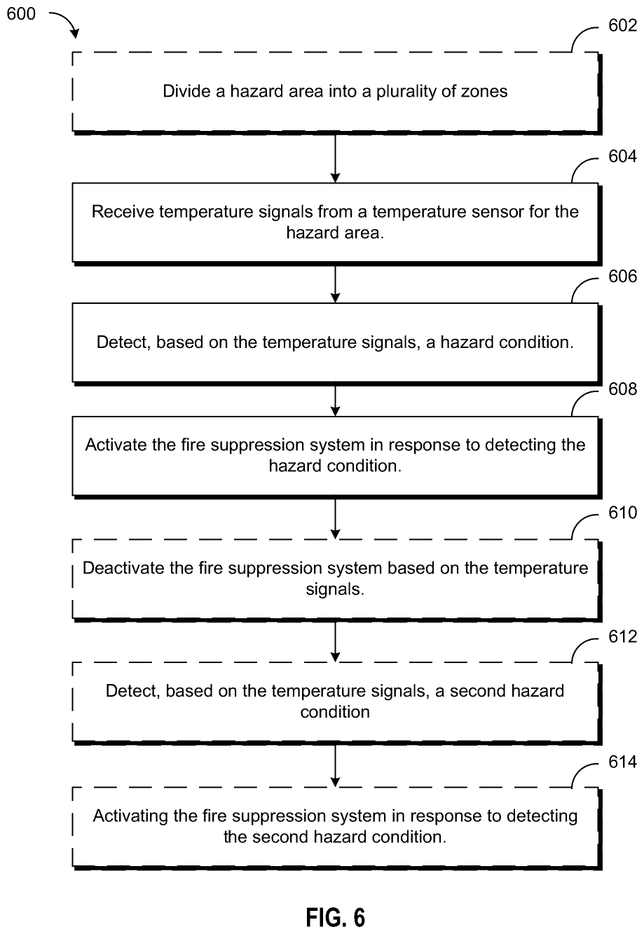

Referring now to FIG. 6, a process 600 for operating a fire detection and suppression system with a temperature sensor is shown, according to some embodiments. Process 600 is shown to include steps 602-614, according to some embodiments. In some embodiments, process 600 is performed by one or more systems described above, such as fire detection and suppression system 200, 300, 400, and/or 500. In some embodiments, process 600 is performed by a controller (e.g., controller 212) and/or any various components of controller of the fire detection and suppression system.

Process 600 includes an optional step of dividing a hazard area into a plurality of zones (step 602), according to some embodiments. In some embodiments, the hazard area is not divided into zones and step 602 is skipped. In some embodiments, the hazard area is divided into zones automatically by a controller of the fire detection and suppression system, such as controller 212. In some embodiments, step 602 is performed by zone manager 316 in hazard detector 314. In some embodiments, step 602 is performed in response to receiving a command, selection, etc. provided by a user (e.g., via remote device 214). In some embodiments, controller 212 is configured to divide a hazard area into zones based on the temperature signals. In some embodiments, the controller 212 is configured to identify appliances in the hazard area based on the temperature signals. In some embodiments, the controller 212 is configured to divide the hazard area into zones based on the location of the detected appliances. In some embodiments, the controller 212 is configured to divide the hazard area into zones based on the temperature signals and/or other data (e.g., image data, radar data, layout/floorplan data, etc.), time, location, use case, etc. In some embodiments, the hazard area is divided into a plurality of zones by a user who provides the location of the zones to the controller 212 via a user input. In some embodiments, the controller 212 divides the hazard area into zones at a first time, monitors the hazard area, and adjust the zones at a second time automatically, based on the temperature signals and/or other data.

Process 600 includes receiving temperature signals from a temperature sensor for the hazard area (step 604), according to some embodiments. In some embodiments, the temperature sensor is temperature sensor 204. In some embodiments, step 604 is performed by controller 212. In some embodiments, step 604 is performed by hazard detector 314 as described above with reference to FIG. 3. In embodiments where the hazard area is divided into zones, the temperature signals can include a zone temperature associated with each zone. In some embodiments, the temperature signal includes the temperatures sensed by each pixel of the temperature sensor 204.

Process 600 includes detecting, based on the temperature signals, a hazard condition (step 606), according to some embodiments. In some embodiments, step 606 is performed by controller 212. In some embodiments, step 606 is performed by hazard detector 314 as described above with reference to FIG. 3. In some embodiments, the hazard condition is detected when maximum temperature condition is satisfied. In some embodiments, the maximum temperature condition is based on one or more characteristics of the zone/hazard it relates to, including its location, size, appliances included within it, average temperature, etc. In some embodiments, the maximum temperature condition is determined by the controller 212 automatically, for example over a learning period. In some embodiments, the maximum temperature condition is provided by a user via user input. In embodiments where the hazard area is divided into a plurality of zones, step 606 includes detecting a hazard condition in at least one of the plurality of zones based on the temperature signals. In some embodiments, a maximum temperature condition is determined and/or provided for each zone.

Process 600 includes activating the fire suppression system in response to detecting the hazard condition (step 608), according to some embodiments. In some embodiments, step 608 is performed by controller 212. In some embodiments, step 608 is performed by activation signal generator 320 and/or suppression system activator 208. In some embodiments, activating the fire suppression system includes activating the entire fire suppression system. In some embodiments, activating the fire suppression system includes activating just a section or portion of the fire suppression system corresponding the with zone or zones the hazard condition(s) is detected within. In some embodiments, the section of the fire suppression system where the hazard condition is detected is activated as well as one or more adjacent sections. In some embodiments, activating the fire suppression system includes sending an electrical signal to automatic activation system 50.

Process 600 includes the optional step of deactivating the fire suppression system based on the temperature signals (step 610), according to some embodiments. In some embodiments, step 610 can be skipped and process 600 proceed directly to optional step 612. In some embodiments, step 610 is performed by controller 212. In some embodiments, step 610 is performed by activation signal generator 320 and/or suppression system activator 208. In some embodiments, the fire suppression system monitors the zones and/or hazard area during actuation of the fire suppression system. In some embodiments, the controller 212 deactivates the fire suppression system prior to the fire suppression system exhausting itself, based on the hazard condition no longer being detected. In some embodiments, the controller 212 deactivates the fire suppression when the maximum temperature condition is no longer satisfied. In some embodiments, the controller 212 is configured to deactivate the fire suppression system when the temperature signals indicate the temperature (or zone temperature) in the hazard area (or zone(s)) is at or below a minimum safe temperature. In some embodiments, the controller 212 is configured to deactivate the fire suppression system in response to a command from a user.

Process 600 includes the optional step of detecting, based on the temperature signals, a second hazard condition (step 612), according to some embodiments. In some embodiments, step 612 is performed by controller 212. In some embodiments, step 612 is performed by hazard detector 314 as described with reference to FIG. 3. In some embodiments, because the temperature sensor 204 remains operable after detecting a fire condition, a fire detection and suppression system can detect a second hazard condition without the need to repair or replace components of the fire detection and suppression system. In some embodiments, the second hazard condition is a reflash of the original hazard condition. In some embodiments, the second hazard condition is located in a zone different than the first hazard condition. For example, controller 212 can detect a first hazard condition in a first zone and activate the section of the fire suppression unit corresponding to the first zone in response to detecting the hazard condition, and the controller 212 can also detect a second fire condition in a second zone different than the first zone.

Process 600 is shown to include the optional step of activating the fire suppression system in response to detecting the second hazard condition (step 614), according to some embodiments. In some embodiments, step 614 is performed by controller 212. In some embodiments, step 614 is performed by activation signal generator 320 and/or suppression system activator 208. In some embodiments, the entire fire suppression system is reactivated. In some embodiments, wherein the first hazard condition is located in a first zone and the second hazard condition is located in a second zone different than the first zone, only the section of the fire suppression associated with the second zone is activated (and or reactivated if previously activated). In some embodiments, the second hazard condition is detected while the first hazard condition is detected. In some embodiments, the controller 212 is configured to activate, at or near the same time, a first section of the fire suppression system associated with a first zone in response to detecting the first hazard condition in the first zone and a second section of the fire suppression system associated with a second zone in response to detecting the second hazard condition in the second zone. In some embodiments therefore, multiple separate zones can be activated and/or activated at the same time in response to separate hazard conditions.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various exemplary embodiments is illustrative only. Although only a few embodiments have been described in detail in this disclosure, many modifications are possible (e.g., variations in sizes, dimensions, structures, shapes and positions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

Additionally, any element disclosed in one embodiment may be incorporated or utilized with any other embodiment disclosed herein. For example, the fusible link 54 of the exemplary embodiment described in at least paragraph [0029] may be incorporated in the automatic activation system 50 of the exemplary embodiment described in at least paragraph [0028]. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A fire detection and suppression system comprising:
a fire suppression system configured to suppress a fire in an area;
a temperature sensor configured to measure a zone temperature for each of a plurality of zones in the area;
a controller configured to:
receive the zone temperatures from the temperature sensor for each of the plurality of zones;
detect a hazard condition in a first zone of the plurality of zones based on the zone temperature for the first zone; and
activate the fire suppression system in response to detecting the hazard condition in the first zone.

2. The fire detection and suppression system of claim 1, wherein the temperature sensor is a grid temperature sensor comprising a plurality of pixels, such that each of the plurality of zones corresponds to at least one of the plurality of pixels of the grid temperature sensor.

3. The fire detection and suppression system of claim 1, wherein the zone temperature for each of the plurality of zones comprises a pixel reading for the plurality of pixels corresponding to each of the zones.

4. The fire detection and suppression system of claim 1, wherein the fire suppression system comprises a first section configured to suppress a fire in the first zone and a second section configured to suppress a fire outside the first zone, wherein the first section and the second section are individually controllable.

5. The fire detection and suppression system of claim 4, wherein the controller is further configured to activate the first section of the fire suppression system in response to detecting the hazard condition in the first zone.

6. The fire detection and suppression system of claim 1, wherein the fire suppression system comprises:
a plurality of nozzles, wherein each of the plurality of zones is associated with at least one of the plurality of nozzles; and
in response to detecting the hazard condition in the first zone, selectively activate at least one of the plurality of nozzles associated with the first zone.

7. The fire detection and suppression system of claim 6, wherein the controller is further configured, in response to detecting the hazard condition in the first zone, to selectively activate at least one of the plurality of nozzles associated with the first zone and at least one of the plurality of nozzles associated with a third zone adjacent to the first zone.

8. The fire detection and suppression system of claim 1, wherein the controller is further configured to:
detect a second hazard condition in the first zone based on the zone temperature for the first zone; and
reactivate the fire suppression system in response to detecting the second hazard condition in the first zone.

9. The fire detection and suppression system of claim 1, wherein the controller is further configured to detect a hazard condition in the first zone when the zone temperature for the first zone satisfies a maximum temperature condition.

10. The fire detection and suppression system of claim 9, wherein the maximum temperature condition is based on an appliance within the first zone.

11. The fire detection and suppression system of claim 9, wherein the controller is further configured to receive the maximum temperature condition via a user input.

12. The fire detection and suppression system of claim 9, wherein the controller is further configured to:
associate an appliance with the first zone; and
determine the maximum temperature condition for the first zone based on the appliance.

13. A method for operating a fire detection and suppression system, comprising:
providing a fire suppression system configured to suppress a fire in an area;
providing a temperature sensor configured to measure a zone temperature for each of a plurality of zones in the area;
detecting, based on the zone temperatures, a hazard condition in at least one of the plurality of zones; and
activating the fire suppression system in response to detecting the hazard condition.

14. The method of claim 13, the fire suppression system comprising:
a fire suppression tank configured to contain a volume of fire suppressant;
a nozzle having an outlet at least selectively fluidly coupled to the fire suppression tank and configured to release a spray of the fire suppressant therefrom; and
an activator configured to selectively release the fire suppressant from the fire suppression tank such that at least a section of the fire suppressant passes through the outlet of the nozzle, wherein the nozzle.

15. The method of claim 13, wherein the fire suppression system comprises a first section configured to suppress a fire in the first zone and a second section configured to suppress a fire outside the first zone, wherein the first section and the second section are individually controllable, the method further comprising the steps of activating the first section of the fire suppression system in response to detecting the hazard condition.

16. The method of claim 13, further comprising:
detecting a second hazard condition in the first zone based on the zone temperature for the first zone; and
reactivating the fire suppression system in response to detecting the second hazard condition in the first zone.

17. The method of claim 13, wherein the temperature sensor comprises a plurality of pixels, such that each of the plurality of zones corresponds to at least one of the plurality of pixels of the temperature sensor.

18. The method of claim 13, wherein the fire suppression system comprises a plurality of individually controllable sections, each section corresponding to at least one of the plurality of zones.

19. A controller for a fire suppression system in a hazard area, the controller comprising processing circuitry configured to:
receive a plurality of zone temperatures from a temperature sensor positioned in the hazard area, wherein each of the plurality of zone temperatures correspond to a zone of a plurality of zones in the hazard area;
detect a hazard condition in a first zone of the hazard area based on a zone temperature of the plurality of zone temperatures corresponding to the first zone; and
activate the fire suppression system in response to detecting the hazard condition in the first zone, wherein the fire suppression system comprises:
a fire suppression tank configured to contain a volume of fire suppressant;
a plurality of nozzles having outlets at least selectively fluidly coupled to the fire suppression tank and configured to release sprays of the fire suppressant therefrom, wherein each of the plurality of nozzles is associated with at least one of the plurality of zones; and
an activator configured to selectively activate the fire suppression system individually in each of the plurality of zones, such that in response to detecting the hazard condition in the first zone the fire suppression system selectively releases fire suppressant in the first zone and not in a second zone of the plurality of zones.

20. The controller of claim 19, wherein the processing circuitry if further configured to:
detect a second hazard condition in the first zone; and
reactivate the fire suppression system in the first zone.
